(19) United States
(12) Patent Application Publication
(10) Pub. No.: US 2025/0348755 A1
(43) Pub. Date: Nov. 13, 2025

(54) TRANSFER LEARNING-BASED OPTIMIZATION

(71) Applicant: Siemens Industry Software NV, Leuven (BE)

(72) Inventors: Suhas Karkada Suresh, Kotathattu Village, Karnataka (IN); Vinay Ramanath, Bengaluru, Karnataka (IN); Sesha Kiran Gundavarapu, Plainsboro, NJ (US); Abhay Kumar, Bangalore, Karnataka (IN); Suja Shree, Chennai (IN)

(21) Appl. No.: 18/867,437

(22) PCT Filed: May 19, 2023
(86) PCT No.: PCT/EP2023/063524

§ 371 Date: Nov. 19, 2024

(30) Foreign Application Priority Data
May 20, 2022 (IN) 202231029218

(51) Int. Cl. G06N 3/0985; G06N 3/096

(52) U.S. Cl. CPC G06N 3/0985; G06N 3/096

(57) ABSTRACT

A system and method for enabling transfer learning-based optimization are provided. The method includes receiving an input indicative of a target optimization task. The target optimization task is associated with an unsolved optimization problem. Similarity between the target optimization task and a source optimization task is determined by applying a predefined similarity checking logic. The source optimization task is associated with a solved optimization problem and a complete optimization history. Complexity scores are computed for the source optimization task and the target optimization task, subject to the outcome of the application of the similarity checking logic, to determine whether the source optimization task is more complex than the target optimization task. If yes, transfer learning is initiated by adapting a target optimizer, for solving the unsolved optimization problem, based on an initial population and one or more model parameters associated with a source optimizer employed in the source optimization task.

This application is the National Stage of International Application No. PCT/EP2023/063524, filed May 19, 2023, which claims the benefit of Indian Patent Application number 202231029218, filed May 20, 2022. The entire contents of these documents are hereby incorporated herein by reference.

### TECHNICAL FIELD

The present embodiments relate to optimization techniques and, more particularly, relate to a system and a method for enabling transfer learning-based optimization.

### BACKGROUND

Optimization tasks within an engineering domain may include repetitive formulations of an optimization problem. Practitioners of optimization re-run the optimization studies, often making minor modifications, such as changes to boundary conditions of the underlying problem, and do not have any mechanism to harness learnings from past optimization studies to accelerate the search in a related problem. In other words, existing optimizers do not consider ‘learnings’ from prior optimization problems while solving related optimization problems. This leads to repetition of search patterns and, therefore, greater lead time for searching of the optimum solution, thus increasing compute power as measured through carbon footprint. Further, optimization problems based on real-world applications require highly reliable data sets that are computationally expensive to generate, and often may be subject to statistical epistemic uncertainty caused by a lack of data points.

Transfer of learnings from a solved optimization problem to a related unsolved optimization problem may alleviate the above-mentioned shortcoming. Therefore, there is a need for a mechanism to identify related optimization problems to an optimization problem at hand. Existing art fails to disclose techniques for identifying related or similar optimization problems. Instead, existing art relies on independently and artificially constructing simpler problems or assuming that two optimization problems are related to each other. Such assumptions might lead to circumstances of negative transfer, where instead of improving, the transfer of learnings hampers the performance of the optimizer.

There exists an opportunity where optimization problems may be classified into groups or families, where the optimization problems exhibiting common features may be grouped together into a single family. Non-limiting examples of such features include nature of design variables, boundary conditions, assumptions, physics of the problem, simulation fidelity, responses, etc. Grouping similar optimization problems into families opens the possibility to leverage learnings within a family of optimization problems and to arrive at strategies for optimization through transfer learning.

In light of the above, there exists a need for a mechanism to perform transfer learning from a solved optimization problem to an unsolved optimization problem, by eliminating possibility of negative transfer of learnings.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a system, an apparatus, and a method for enabling transfer learning-based optimization as disclosed herein are provided.

The method includes receiving from a client device, by a processing unit, an input indicative of at least a target optimization task. The target optimization task is associated with an unsolved optimization problem. The method further includes determining similarity between the target optimization task and at least one source optimization task by applying a predefined similarity checking logic. The source optimization task is associated with a solved optimization problem and a complete optimization history thereof. In an embodiment, determining similarity between the target optimization task and the at least one source optimization task by applying the predefined similarity checking logic includes performing a low-level check to determine similarities based on at least one of metadata and features present in the source optimization task and the target optimization task. Further, if the low-level check is indicative of a similarity between the source optimization task and the target optimization task, a high-level check is performed to compute a plurality of similarity indices. Further, an outcome is determined based on values of the plurality of similarity indices. The outcome is indicative of similarity or dissimilarity between the source optimization task and the target optimization task. In an embodiment, the high-level check is based interpretable Self-Organizing Maps, image comparison, Pearson similarity index, Cosine similarity index, Jaccard similarity index, Mean Squares, Structural Similarity Index, and/or visualization.

The method further includes generating an output indicative of the outcome of applying the similarity checking logic, on a user interface of the client device.

In a further embodiment, the method further includes computing complexity scores associated with each of the source optimization task and the target optimization task using a predefined logic, subject to the outcome of applying the similarity checking logic. Further, the estimated complexity scores associated with each of the source optimization task and the target optimization task are compared to determine whether a complexity of the source optimization task is greater than a complexity of the target optimization task.

In an embodiment, the method further includes initiating transfer learning from the source optimization task to the target optimization task, if complexity of the source optimization task is greater than complexity of the target optimization task. In an embodiment, initiating transfer learning from the source optimization task to the target optimization task includes selecting a target optimizer from a plurality of optimizers based on the optimization history of the solved optimization problem. In a further embodiment, the method includes, first, identifying, from the source optimization task, an initial population and one or more model parameters associated with a source optimizer employed in the source optimization task. The one or more model parameters are associated with least model error in the source optimizer. Further, the target optimizer is adapted based on the identified initial population and the one or more model parameters. The adapted target optimizer is further used for generating a solution to the unsolved optimization problem. In an embodiment, each of the source optimizer and the target optimizer is a metaheuristic optimization algorithm. In a further embodiment, the metaheuristic optimization algorithm is a genetic algorithm or a neural network algorithm.

In an embodiment, the method further includes generating a notification indicative of at least the solution to the unsolved optimization problem, on the user interface of the client device.

As another example, an apparatus for enabling transfer learning-based optimization is provided. The apparatus includes one or more processing units and a memory unit communicatively coupled to the one or more processing units. The memory unit includes a comparison module stored in the form of machine-readable instructions executable by the one or more processing units. The comparison module is configured to perform method acts described above. The execution of the comparison module may also be performed using co-processors such as Graphical Processing Unit (GPU), Field Programmable Gate Array (FPGA), or Neural Processing/Compute Engines. In addition, the memory unit may also include a database.

As yet another example, a system for enabling transfer learning-based optimization is provided. The system includes one or more client devices, and an apparatus, communicatively coupled to the one or more client devices, configured for enabling transfer learning-based optimization problems based on inputs received from the one or more client devices according to any of the method acts as described above.

As another example, a computer program product is provided. The computer-program product may be, for example, a computer program or include another element apart from the computer program. This other element may be hardware (e.g., a memory device, on which the computer program is stored, a hardware key for using the computer program, and the like) and/or software (e.g., a documentation or a software key for using the computer program).

As yet another example, a computer-readable medium, on which program code sections of a computer program are saved, is provided. The program code sections are loadable into and/or executable by a processor that performs the method as described above when the program code sections are executed.

The realization of one or more of the present embodiments by a computer program product and/or a non-transitory computer-readable storage medium has the advantage that computer systems may be easily adopted by installing computer program to work as proposed by the present embodiments.

The computer program product may be, for example, a computer program or include another element apart from the computer program. This other element may be hardware (e.g., a memory device, on which the computer program is stored, a hardware key for using the computer program, and the like) and/or software (e.g., a documentation or a software key for using the computer program).

The attributes, features, and advantages of the present embodiments and the manner of achieving them will become more apparent, and clear and understandable with the following description of embodiments in conjunction with the corresponding drawings. The illustrated embodiments are intended to illustrate but not limit the invention.

### BRIEF DESCRIPTION OF FIGURES

FIG. 1A illustrates a block diagram of a system for enabling transfer learning-based optimization, according to an embodiment;

FIG. 1B illustrates a block diagram of a system for enabling transfer learning-based optimization, according to an embodiment;

FIG. 2 shows a flowchart of a method 200 for managing optimization problems, in accordance with an embodiment;

FIG. 3 shows a detailed flowchart of an exemplary method 300 for performing similarity checks, in accordance with an embodiment;

FIG. 4 shows a flowchart of a method of enabling optimization of an unsolved optimization problem based on transfer learning from a solved optimization problem, in accordance with an example embodiment;

FIG. 5 shows an example workflow for transfer learning-based optimization using genetic algorithm, in accordance with an example embodiment;

FIG. 6A shows an example workflow for optimization using neural network algorithm (source optimizer), in accordance with an embodiment;

FIG. 6B shows an example workflow of performing transfer learning-based optimization using neural network algorithm (target optimizer), in accordance with an embodiment;

FIG. 7 shows a plot indicative of convergence of optimization for two similar functions, a 2D sphere function, and a 2D Bohachevsky function, using transfer learning based on neural network algorithm and genetic algorithm, and without using transfer learning;

FIG. 8 shows a plot indicative of convergence of optimization for two dissimilar functions, a 2D sphere function and a 2D Matyas function, using transfer learning based on neural network algorithm and genetic algorithm, and without using transfer learning;

FIG. 9 is a plot showing comparison between convergence of optimization with and without transfer of learnings from the optimization problem for IPMSMX to the optimization problem for IPMSMA;

FIG. 10 shows a plot showing comparison between convergence of optimization with and without transfer of learnings from the optimization problem for IPMSMX to the optimization problem for SCIM6; and

FIG. 11 shows a plowing comparison between convergence of optimization with and without transfer learnings from a knowledge-deficit source problem to a knowledge-rich target problem.

### DETAILED DESCRIPTION

Hereinafter, embodiments are described in detail. The various embodiments are described with reference to the drawings, where like reference numerals are used to refer to like elements throughout. In the following description, for purpose of explanation, numerous specific details are set forth to provide a thorough understanding of one or more embodiments. It may be evident that such embodiments may be practiced without these specific details.

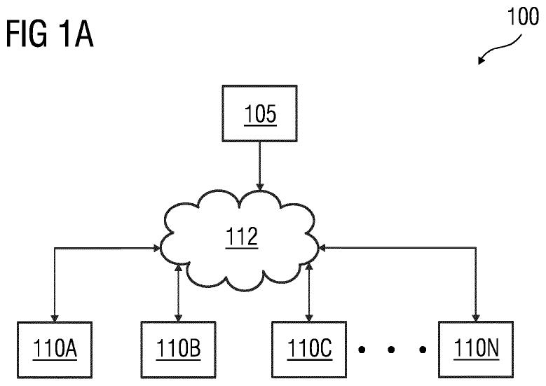

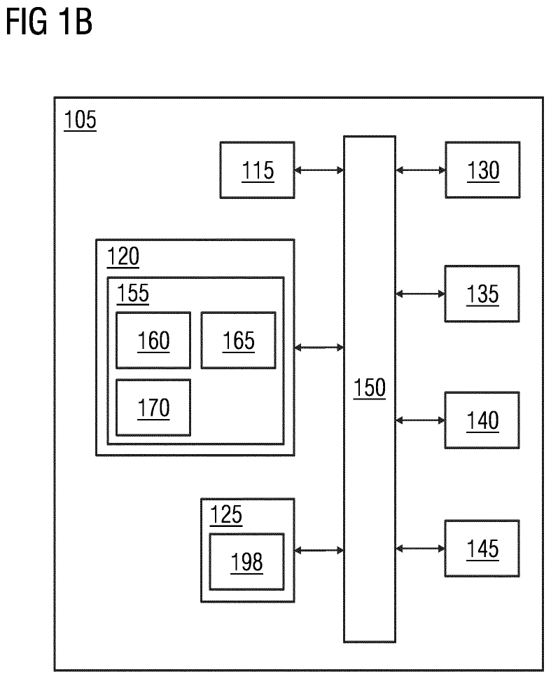

FIG. 1A illustrates a block diagram of a system 100 for enabling transfer learning-based optimization, according to an embodiment.

The system 100 includes an apparatus 105 and a plurality of client devices 110A-N (collectively referred hereinafter as client device 110). Each of the client devices 110A-N is connected to the apparatus 105 via a network 112 (e.g., local area network (LAN), wide area network (WAN), Wi-Fi, etc.). In one embodiment, the apparatus 105 is a computing system implemented in a cloud computing environment. As used herein, “cloud computing environment” refers to a processing environment including configurable computing physical and logical resources (e.g., networks, servers, storage, applications, services, etc.) and data distributed over the network (e.g., the internet). The cloud computing environment provides on-demand network access to a shared pool of the configurable computing physical and logical resources.

The apparatus 105 includes a processing unit 115, a memory 120, a storage unit 125, a communication module 130, a network interface 135, an input unit 140, an output unit 145, a standard interface or bus 150, as shown in FIG. 1B. The apparatus 105 may be a (personal) computer, a workstation, a virtual machine running on host hardware, a microcontroller, or an integrated circuit. As an alternative, the apparatus 105 may be a real or a virtual group of computers (the technical term for a real group of computers is “cluster”, the technical term for a virtual group of computers is “cloud”). The term ‘processing unit,’ as used herein, may be any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 115 may also include embedded controllers, such as generic or programmable logic devices or arrays, application specific integrated circuits, single-chip computers, and the like. In general, a processing unit 115 may include hardware elements and software elements. The processing unit 115 may be configured for multithreading (e.g., the processing unit 115 may host different calculation processes at the same time, executing either in parallel or switching between active and passive calculation processes).

The memory 120 may include one or more of a volatile memory and a non-volatile memory. The memory 120 may be coupled for communication with the processing unit 115. The processing unit 115 may execute instructions and/or code stored in the memory 120. A variety of computer-readable storage media may be stored in and accessed from the memory 120. The memory 120 may include any suitable elements for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like. The memory 120 includes a comparison module 155. The comparison module 155 may be stored in the memory 120 in the form of machine-readable instructions and may be executable by the processing unit 115. These machine-readable instructions, when executed by the processing unit 115, causes the processing unit 115 to enable transfer learning-based optimization. The comparison module 155 includes a metadata extractor module 160, a similarity validator module 165, and a transfer learning orchestration module 170, as shown in FIG. 1B.

The similarity validator module 165 is configured for receiving from the client device 110 an input indicative of a target optimization task. The target optimization task is associated with an unsolved optimization problem. The target optimization task may include no optimization history or only a partial optimization history. The terms “optimization history” or “history of optimization runs” may be used interchangeably in the present disclosure to indicate optimization data, number of iterations, stopping criteria, features, metadata, etc., associated with an optimization problem. The term “number of iterations,” as used herein, refers a count of intermediate “correction” steps or iterations that an optimizer undergoes until an optima is identified.

The similarity validator module 165 is further configured for determining similarity between the target optimization task and at least one source optimization task by applying a predefined similarity checking logic. The source optimization task is associated with a solved optimization problem and a complete optimization history thereof. The similarity index is indicative of a degree of similarity between the source optimization task and the target optimization task. The source optimization task is a first graph data structure including metadata and a trace or complete history of optimization runs associated with solving of the source problem. In an example, the source optimization task may be stored in a JSON file. The target optimization task is a second graph data structure including at least metadata associated with the target problem.

The similarity validator module 165 is further configured for generating an output indicative of an outcome of the application of the similarity checking logic, on a user interface of the client device 110.

The transfer learning orchestration module 170 is configured for computing complexity scores associated with each of the source optimization task and the target optimization task using a predefined logic, subject to the outcome of the application of the similarity checking logic. The transfer learning orchestration module 170 is further configured for determining whether a complexity of the source optimization task is greater than a complexity of the target optimization task, by comparing the estimated complexity scores associated with each of the source optimization task and the target optimization task. The transfer learning orchestration module 170 is further configured for initiating transfer learning from the source optimization task to the target optimization task, if complexity of the source optimization task is greater than complexity of the target optimization task.

The apparatus 105 may include a network interface 135 for communicating with the client devices 110 via the network 112. Each of the client devices 110A-N include a user interface (not shown) that enables a user to upload information relevant for performing transfer learning-based optimization of an optimization task. The user interface may be further configured, by the apparatus 105, to generate an output indicative of a solution to the optimization problem upon performing the transfer learning-based optimization. Further, the user interface may also be configured, by the apparatus 105, to generate an output indicative of, for example, similarity indices, complexity scores, number of iterations, or results of other intermediate processes related to a given optimization technique. In an embodiment, the user interface of the client device 110 may be provided by a web-based or client-based application on the client device 110.

The storage unit 125 includes a non-volatile memory that includes a database 175. The database 175 stores one or more source optimization tasks. The input unit 140 may include input device(s) such as keypad, touch-sensitive display, camera, etc. capable of receiving input signal. The bus 150 acts as an interconnect between the processing unit 115, the memory 120, the storage unit 125, and the network interface 135. The communication module 130 enables the apparatus 105 to communicate with the client devices 110A-N. The communication module 130 may support different standard communication protocols such as Transport Control Protocol/Internet Protocol (TCP/IP), Profinet, Profibus, and Internet Protocol Version (IPv).

An apparatus 105 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed, and/or an event such as clicking a mouse button may be generated to actuate a desired response.

One of various commercial operating systems, such as a version of Microsoft Windows™, a product of Microsoft Corporation located in Redmond, Washington may be employed if suitably modified. The operating system is modified or created in accordance with the present disclosure as described.

Those of ordinary skilled in the art will appreciate that the hardware depicted in FIGS. 1A, 1B, and 1C may vary for different implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter, network connectivity devices may also be used in addition to or in place of the hardware depicted. The depicted example is provided for the purpose of explanation only and is not meant to imply architectural limitations with respect to the present disclosure.

The present embodiments are not limited to a particular computer system platform, processing unit, operating system, or network. One or more aspects of the present embodiments may be distributed among one or more computer systems (e.g., servers) configured to provide one or more services to one or more client computers, or to perform a complete task in a distributed system. For example, one or more aspects of the present embodiments may be performed on a client-server system that includes components distributed among one or more server systems that perform multiple functions according to various embodiments. These components include, for example, executable, intermediate, or interpreted code that communicates over a network using a communication protocol. The present embodiments are not limited to be executable on any particular system or group of system, and are not limited to any particular distributed architecture, network, or communication protocol.

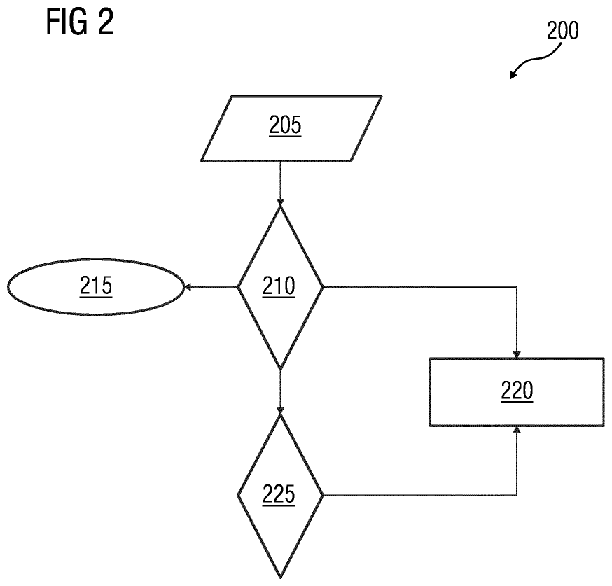

FIG. 2 shows a flowchart of a method 200 for managing optimization problems, in accordance with an embodiment. The method is implementable in the form of machine-readable instructions on the apparatus 105.

At act 205, an input indicative of at least a target optimization task is received from the client device 110, by the processing unit 115. The target optimization task is associated with an unsolved optimization problem.

In an embodiment, the input may be received in the form of a configuration file. The configuration file may include at least one indication of the target optimization task. To identify the target optimization task from the configuration file, the metadata extraction module 170 may parse the received configuration file to extract metadata corresponding to the target problem. The metadata is further stored in a graph data structure along with a unique ID, within the database 175. This graph data structure forms the target optimization task. In an implementation, the configuration file may also include, if available, a partial history of optimization associated with the unsolved optimization problem. Alternatively, the configuration file may include a location within the database 175 where the partial optimization history is stored. The partial optimization history of the unsolved optimization problem may help in faster convergence to a solution, during transfer learning-based optimization.

In another implementation, the configuration file may also include an indication of a source optimization task. The source optimization task is associated with a solved optimization problem and a complete optimization history thereof. If the configuration file includes an indication of the source optimization task and the complete optimization history thereof, the metadata extractor module 160 dynamically extracts metadata associated with the source optimization task by parsing the configuration file, to identify the source optimization task, similar to the process of generating the target optimization task. This is helpful when the user is interested in determining whether transfer learning is possible from a source optimization task of interest to the target optimization task. Alternatively, the configuration file may only indicate a location within the database 175 where the source optimization task is stored. For example, the source optimization task may be associated with optimization of a 2D sphere function, and the target optimization task may be optimization of a 2D Bohachevsky function.

At act 210, similarity between the target optimization task and at least one source optimization task is determined by applying a predefined similarity checking logic.

If the configuration file does not include any indication of the source optimization task, a source optimization task may be selected from a plurality of source optimization tasks stored in the database 175, based on a predetermined order.

The similarity checking logic helps in determining whether the solved optimization problem and the unsolved optimization problem belong to the same “class” of optimization problems. This is because efficient transfer learning may happen from the source optimization task to the target optimization task, only if the solved optimization problem and the unsolved optimization belong to the same class of optimization problems.

The similarity checking logic may perform similarity check on two levels, a preliminary low-level check and an advanced high-level check. The low-level check is performed to determine similarities based on metadata and/or features present in the source optimization task and the target optimization task. This is because, in case of optimization problems belonging to different classes, metadata or features may differ. The term ‘metadata,’ as used herein, refers to a series of datasets that are representative of influence of inputs on output of an optimization problem. Non-limiting examples of metadata may include values and ranges of parameters, variables, and responses. For example, presence of quadratic terms in the optimization function result in a convex response.

The term ‘features,’ as used herein, refers to attributes that indicate how the optimization problem behaves in a search space. Non-limiting examples of features include nature of response space, complexities, non-linearity, types of Pareto front, type of design space, types of physics, and types of multi-physics. In an example, if a count of the number of features, types of features, and boundary conditions are the same, the source optimization task and the target optimization task may be determined to be similar at the low-level check. The low-level check establishes dissimilarity between the source optimization task and the target optimization task based on the metadata or features of the source optimization task and the target optimization task, thereby eliminating the need for the high-level check. In case of such dissimilarity, the method ends at act 215. Further, the target optimization task may be stored in the database 175 as a new entry.

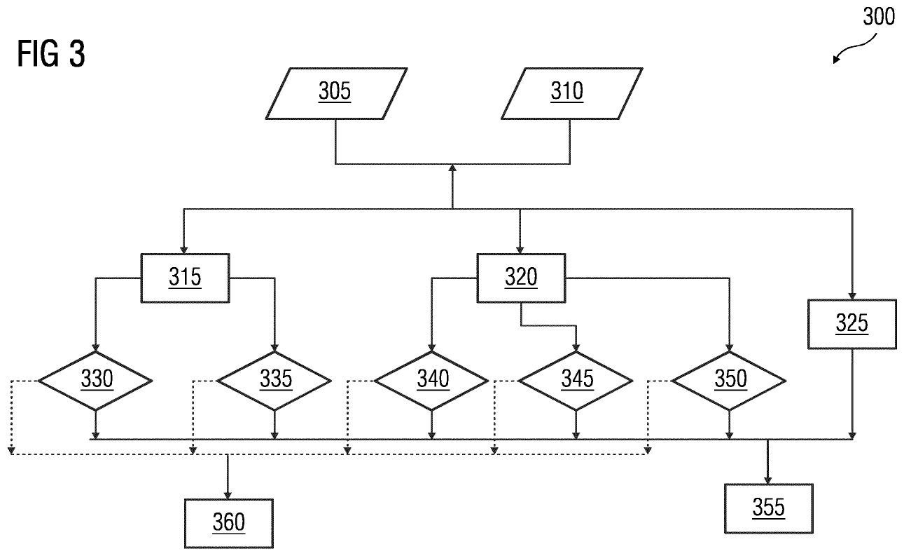

If an output of the low-level check is indicative of a similarity between the source optimization task and the target optimization task, the high-level check is performed to compute a plurality of similarity indices. The similarity indices are computed based on optimization data such as distribution of variables and responses, mean and standard deviation, etc. If at least a predefined number of similarity indices among the plurality of similarity indices is indicative of similarity, then the outcome of the application of the similarity checking logic may indicate similarity between the source optimization task and the target optimization task. The use of two-level similarity check along with computation of multiple similarity indices helps in improving confidence in the outcome of the application of the similarity checking logic. An example high-level check is explained later with reference to FIG. 3.

In case the input received from the client device 110 includes no indication of the source optimization task, the act 210 may be repeated for every source optimization task present within the database 175 until a source optimization task similar to the target optimization task is identified.

In one embodiment, use of the low-level check and the high-level check helps in optimizing usage of computing resources in assessment of similarity between the source optimization task and the target optimization task. The high-level check performed helps in ascertaining similarity between the source optimization task and the target optimization task with greater confidence once the low-level check is successful. In an embodiment, the user may be provided an option to decide whether the high-level check is to be performed, based on an outcome of the low-level check. For example, if the low-level check determines the source optimization task and the target optimization task to be similar, the user may be provided an option to select ‘Yes’ or ‘no’ in response to a textual prompt such as “Do you want to proceed with the high-level check?”

At act 215, an output indicative of the outcome of the application of the similarity checking logic is generated on a user interface of the client device 110.

FIG. 3 shows a detailed flowchart of an example method 300 for performing a high-level check, in accordance with an embodiment.

In the present embodiment, a source optimization task 305 and a target optimization task 310 are first compared, using an interpretable Self-Organizing Map (iSOM) similarity check (shown as act 315), an image similarity check (shown as act 320), and a visualization approach (shown as act 325).

Here, iSOM similarity check is an algorithm that employs a modified version of conventional Self-Organizing Maps (SOM). The SOM is an artificial neural network (ANN) based on unsupervised learning techniques, used as a visualization tool for higher-dimensional data. An input to the SOM includes high-dimensional data, and an output of the SOM includes a ‘map’ or visual representation of the high-dimensional data on a two-dimensional space. The architecture of a SOM includes two layers, an input layer, and an output layer. Unlike other artificial neural networks, SOMs lack an activation layer. As a result, weights are directly passed to neurons in the output layer. Each neuron in the output layer is assigned a weight vector corresponding to a dimensionality of the input dataset (hereinafter referred to as ‘input space’).

In one embodiment, SOMs generate visual representations that preserve a topology of the high-dimensional input space unlike other visualization tools. In other words, mapping of high-dimensional data to a map of lower dimension preserves relative distances between input data points.

Unlike ANNs that employ error-correction based learning techniques such as back propagation with gradient descent, SOMs employ competitive learning. The competitive learning includes three processes (e.g., competition, cooperation, adaptation).

Each neuron in the output layer carries a weight vector of dimensionality equal to the input space. Thus, if the input space includes ‘n’ variables, each neuron in the output layer carries an n-dimensional weight vector. In the competition phase, distance between each neuron in the output layer to the input layer is measured using Euclidean metric. Based on the distance measured, an output neuron closest (e.g., at lowest distance) to the input layer is identified as a winning neuron in the competition phase.

During cooperation phase, weight vectors of each neighboring vectors of the winning neuron are updated. Subsequently, a neighborhood kernel function is used to select neighboring neurons for updating of weight vectors during each training cycle. In one embodiment, the neighborhood kernel function preserves topological properties of the n-dimensional input space. The neighborhood kernel function relies on two factors (e.g., time and the distance between the winning neuron and each of the neighboring neurons) to select the neighboring neuron for updating the respective weight vector.

During the adaptation phase (e.g., after the winner neuron and the neighboring neurons are decided), a map generated by the output layer realigns to take a shape corresponding to the dimension of the input space.

The weight vectors of the neighboring neurons of a winner neuron are updated using the below equation:

$${w}_{k} = {w}_{k} - η ( t ) , {h}_{tk} ( t ) , ( {x}^{η} - {w}_{k} ) \qquad ( 1 )$$

The learning rate used for the ANN is an exponentially decaying function as shown below:

$$η ( t ) = {η}_{o} exp ( \frac{- t}{{r}_{1}} ) \qquad ( 2 )$$

As time ‘t’ increases, the learning rate converges to zero. Consequently, the winner neuron is not updated once the learning rate converges to zero. This also serves as a termination criterion for iterations of the ANN.

In conventional SOM, the winning neuron identified during an initial iteration may get altered in a subsequent iteration due to the neighborhood kernel function. The iterations are repeated until at least one predefined termination criterion is met. The predefined termination criterion may correspond to a specified convergence of error or exhaustion of allowable function evaluations. However, during each iteration, there exists a possibility that a map generated by the output layer may fold and self-intersect. This may affect visualization and interpretation of the input data.

Therefore, the iSOM algorithm is used instead of a conventional SOM algorithm for assessing the similarity. In iSOM, the winning neurons are chosen by using data from the input space (e.g., unlike conventional SOM, which uses both input and output values), and the weights of the respective node and the ones in its neighborhood are updated as the difference between the data point and respective response.

In the present embodiments, the iSOM algorithm is used to obtain two-dimensional visual representations of metadata or features associated with each of the source optimization task and target optimization task. In an example, the visual representation includes a map formed by a plurality of hexagonal regions. Each hexagon of the map represents a neuron in the output layer of the ANN. The weight vectors of the neurons in the output layer of the ANN for both the source optimization task and the target optimization task may be compared against each other to identify similarities. The weight vectors associated with each of the neurons contain information about position of the neuron in the input space, which in turn depicts a topology of the optimization problem. Thus, comparison of the weight vectors of neurons in the output layer also implies comparison of structural similarity between the unsolved optimization problem and the solved optimization problem.

At act 320, the maps or visual representations obtained at step 315 are further converted into image objects and provided to a comparison engine to perform image similarity check. The image similarity check involves comparison the images corresponding to the source optimization task and the TOT. Herein, a comparison engine compares each pixel in the image of the source optimization task with a corresponding pixel in the image of the target optimization task. More specifically, the comparison engine identifies color of the pixel in the map of the source optimization task and compares the identified color with color of the corresponding pixel in the image of the TOT. If the colors coincide, the comparison engine determines the images to be identical. Further, the comparison engine generates a value that quantifies visual similarity between the images as output.

The performance of the comparison engine is associated with a plurality of predetermined parameters. In an example, the user may specify the parameters in the configuration file. In another example, the parameters may assume default values. Each of the parameters enables additional processing of bit images, which makes comparison more flexible. Non-limiting examples of such parameters include pixel tolerance, color tolerance, transparent color, and comparison mask. Here, the parameter ‘pixel tolerance’ defines an allowed number of dissimilar pixels. If the number of dissimilar pixels is less than or equal to the pixel tolerance, then the comparison engine identifies the images to be identical. The parameter ‘color tolerance’ specifies an acceptable color difference at which two pixels may be treated as identical. In an example, the color difference is represented as an integer value within the range 0 to 255 that specifies an acceptable difference for intensity of each color component (e.g., red, green, and blue) of the compared pixels. Two pixels are considered identical if the difference between intensities of each of their color components does not exceed the color tolerance.

The parameter ‘transparent color,’ when enabled, causes the comparison engine to treat the color of the upper-left pixel of the image as a transparent color and does not compare all the pixels that have the same coordinates in the compared image as the transparent pixels in the image, similar to the way transparency is implemented in the .ICO and .GIF formats.

The parameter ‘comparison mask’ specifies areas of the images to be compared. The comparison mask is another image having pixels that may be either black or white. If a comparison mask is specified, white pixels within the comparison mask are considered during comparison, whereas black pixels are ignored. Unlike in the case of defining transparent color, the image need not be modified when a comparison mask is used.

There are various other techniques that may be followed for image comparison apart from the above-described techniques. In the present embodiment, an image comparison technique is used as another method to identify structural similarity between the source optimization task and the target optimization task.

Further, similarity indices are computed to obtain a quantitative value for the similarity between the source optimization task and the target optimization task. In the present example embodiment, the similarity indices are based on computation of cosine similarity index (at act 330), Pearson similarity index (at act 335), Mean Squares Error (MSE) (at act 340), structural similarity index (SSI) (at act 345), and Jaccard similarity index (at act 350).

Each of cosine similarity index and Pearson similarity index measure similarity between two vectors of an inner product space, measured by the cosine of the angle between two vectors. In the present embodiment, calculation of cosine similarity index and Pearson similarity index is performed in conjunction with the iSOM technique explained earlier and the Active subspace and manifolds technique. In the case of the iSOM technique, the closeness of the weight vectors of the neurons in the output layer of the ANN corresponding to the source optimization task and the target optimization task is used to compute cosine similarity index and Pearson similarity index. In the case of an active subspace and manifolds technique, a one-dimensional directional vector is used to compute Cosine and Pearson similarity value.

In one embodiment, both Cosine similarity index and Pearson similarity index are independent of magnitude, and may therefore be used to find similarity even if the weight vectors are far separated from each other in the vector space. The formulas used to compute the similarities are listed below:

If M=[v₁, v₂, . . . , v_{N}] and L=[u₁, u₂, . . . , u_{N}] are two vectors, cosine similarity index for M and L is computed as:

$${S}_{cosine} ( M , L ) = \frac{〈 M , L 〉}{‖ M ‖ ‖ L ‖} \qquad ( 3 )$$

$$where , 〈 M , L 〉 = {M}^{T} L = ( {v}_{1} {u}_{1} ) + … + ( {v}_{n} {u}_{n} ) \qquad ( 4 )$$

$$‖ M ‖ = \sqrt{{\sum }_{i = 1}^{N} {( {v}_{i} )}^{2}} \text{?} ‖ L ‖ = \sqrt{{\sum }_{i = 1}^{N} {( {u}_{i} )}^{2}} \qquad ( 5 )$$

$$\text{?} \text{indicates text missing or illegible when filed}$$

Whereas Pearson similarity index is computed as:

$$〈 M , L 〉 = {M}^{T} L = ( ( {v}_{1} - \overline{v} ) ( {u}_{1} - \overline{u} ) ) + … + ( ( {v}_{n} - \overline{v} ) ( {u}_{n} - \overline{u} ) ) \qquad ( 6 )$$

$$‖ M ‖ = \sqrt{{\sum }_{i = 1}^{N} {( {v}_{i} - \overline{v} )}^{2}} \text{?} ‖ L ‖ = \sqrt{{\sum }_{i = 1}^{N} {( {u}_{i} - \overline{u} )}^{2}} \qquad ( 7 )$$

$$\text{?} \text{indicates text missing or illegible when filed}$$

It may be understood by a person skilled in the art that image comparison may be limited to a particular region of each image. Similarity indices for images such as MSE, SSI, and Jaccard similarity value provide a quantitative evaluation of the similarity between two image objects or two image regions within the image objects.

Here, MSE is a sum of squared differences between intensity values of pixels in the compared images. It may be understood that calculation of MSE requires intensity values in the image objects to be in the same range.

$$MSE ( x , y ) = mean ( {\sum }_{i = 0}^{n} {( {Y}_{i} - {Y}_{i}^{1} )}^{2} ) \qquad ( 8 )$$

where,
Y—reference image object generated from iSOM map corresponding to the source optimization task.
Y¹—image object generated from the iSOM map corresponding to the target optimization task.

The SSI is calculated on various windows of an image. For two windows x and y of common size N×N, SSI is calculated:

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad ( 9 )$$

where,
μₓ is the average of x;
μ_{y} is the average of y;
σₓ² of is the variance of x;
σ_{y}² is the variance of y;
σ_{xy} is the covariance of x and y; and
c₁ and c₂ are variables of pixel values to stabilize the division with weak denominator.

The Jaccard similarity value, also known as the Jaccard similarity coefficient, is a statistic used for gauging similarity and diversity of two image objects.

$$Jaccard ( Y , {Y}^{1} ) = \frac{\vert Y ⋂ {Y}^{1} \vert}{\vert Y ⋃ {Y}^{1} \vert} \qquad ( 10 )$$

where
Y is the reference image
Y¹ is the image compared

The visualization technique, performed at act 325, involves human intervention, where the similarity between the source optimization task and the target optimization task is determined by the user, based on visual similarity. In the present embodiment, visualization includes displaying the iSOM maps corresponding to the source optimization task and the target optimization task to the user. Further, the user may be provided a plurality of predefined category labels to choose from. For example, the category labels may include ‘very similar’, ‘similar’, ‘somewhat similar’, ‘dissimilar’, and ‘very dissimilar’. Each category is weighted with weights ranging from 0.2 to 1, where 1 represents maximum similarity and 0.2 represents the least similarity.

As mentioned earlier, if at least a predefined number of similarity indices among the plurality of similarity indices is indicative of similarity, then the outcome of the application of the similarity checking logic may indicate similarity between the source optimization task and the target optimization task. For example, if the similarity index is cosine similarity, then a value above 0.9, for example, may indicate similarity; if the similarity index is mean square error (MSE), a value below 0.10, for example, may indicate similarity, etc. In an example, a total of six different types of similarity indices may be computed. If, for example, four out of the six similarity indices indicate similarity, then the outcome of the application of the similarity checking logic may indicate that the solved optimization problem and the unsolved optimization problem are determined to be from the same class of optimization problems as shown by act 355.

Consequently, transfer learning may be used to transfer learnings to the target optimization task from the source optimization task. Otherwise, the unsolved optimization problem is determined to be dissimilar, as shown by act 360. Consequently, transfer of learnings from the source optimization task to the target optimization task may not be effective in solving the unsolved optimization problem. Hereinafter, references to “transfer of learnings” from one optimization problem to another optimization problem should be construed as transfer of learnings between the respective optimization tasks of the optimization problems (e.g., from the source optimization task to the target optimization task).

Table 1 below shows experimental results for similarity indices computed for two structurally similar functions, a 2D sphere function and a 2D Bohachevsky function:

TABLE 1
Experimental results for similarity indices computed of
a 2D sphere function and a 2D Bohachevsky function
Similarity Analysis

| | |
|---|---|
| Cosine Similarity | 0.9857 |
| Pearson Similarity | 0.8972 |
| SSIM | 0.9287 |
| MSE | 0.0035 |
| 1-- Norm MSE | 0.9965 |
| Jaccard Similarity | 0.9341 |
| Visualization | Very Similar |

Table 2 shows similarity indices for two dissimilar functions, 2D Sphere function and 2D Matyas function:

TABLE 2
Experimental results for similarity indices of
a 2D Sphere function and 2D Matyas function
Similarity Analysis

| | |
|---|---|
| Cosine Similarity | 0.8645 |
| Pearson Similarity | 0.3652 |
| SSIM | 0.8569 |
| MSE | 0.033 |
| 1-- Norm MSE | 0.967 |
| Jaccard Similarity | 0.4447 |
| Visualization | Dissimilar |

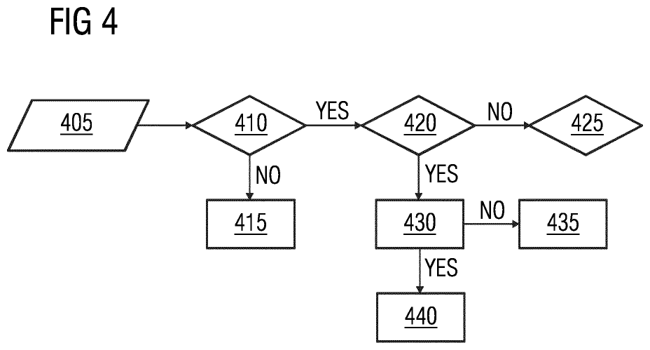

FIG. 4 shows a flowchart of a method 400 of enabling optimization of an unsolved optimization problem based on transfer learning, in accordance with an example embodiment. Hereinafter, the term “target problem” may be used to refer to the unsolved optimization problem, while the term “source problem” may be used to refer to a solved optimization problem for which a complete optimization history is readily available. In the present embodiment, optimization of both the source problem and the target problem are based on metaheuristic optimization algorithms. The present disclosure is explained by taking examples of two metaheuristic optimization algorithms, neural network algorithm and genetic algorithm. However, it may be understood by a person skilled in the art that the teachings of the present disclosure may be extended to other types of metaheuristic algorithms such as particle swarm optimization, artificial bee colony optimization, tabu search, and the like. In general, the teachings of the present embodiments may be applied to any optimization algorithm (e.g., an optimizer) that is independent of dimensionality. Hereinafter, the term ‘source optimizer’ is used to refer to an optimizer employed in the source optimization task for solving the source problem. Similarly, the term ‘target optimizer’ is used to refer to the optimizer to be employed in a target optimization task for solving the target problem.

At act 405, an input indicative of at least a target optimization task is received, by the processing unit 115, from the client device 110. Further, a source optimization task and a target optimization task are generated based on the inputs, as explained earlier with reference to acts 205 and 210 of method 200.

At act 410, similarity between the source optimization task and the target optimization task is determined using a similarity checking logic, as explained earlier with reference to act 210 of method 200, and FIG. 3. If an outcome of the application of the similarity checking logic indicates that the source optimization task and the target optimization task are dissimilar, the method ends at act 415. Otherwise, act 420 is performed.

At act 420, a complexity score associated with each of the source problem and the target problem are computed using a predefined logic. The complexity score is a numerical value indicative of a degree of complexity associated with an optimization problem. The transfer of learnings from a source optimization task to a target optimization task may happen only if the complexity associated with the source optimization task is greater than that of the target optimization task. In an implementation, the complexity score may be computed for a given optimization problem, using a predefined logic, based on number of variables or features in the corresponding optimization task. Further, the estimated complexity scores are compared to determine whether the complexity of the source optimization task is greater than the complexity of the target optimization task. If no, the method ends at act 425. Otherwise, the transfer learning process is initiated as in acts 430, 435, and 440.

At act 430, a target optimizer is selected from a plurality of optimizers based on the optimization history of the source problem. In the present embodiment, the plurality of optimizers includes a neural network algorithm and a genetic algorithm. More specifically, if optimization data corresponding to genetic algorithm-based optimization is available in the source optimization task, then the genetic algorithm is selected as the target optimizer as shown in act 440. Otherwise, the neural network algorithm is selected as the target optimizer as shown in act 435.

Upon selecting the target optimizer, transfer learning is initiated to the target optimization task from the source optimization task. In the present embodiment, transfer learning includes identifying an initial population and one or more model parameters associated with the source optimizer. The one or more model parameters correspond to least model error in the source optimizer. Further, the target optimizer is adapted based on the identified initial population and the one or more model parameters. The adapted target optimizer is further used to generate a solution to the target problem.

Herein, the term ‘model parameter’ may refer to one or more parameters associated with an optimizer used for solving an optimization problem. For example, if the optimizer is based on the genetic algorithm, the model parameters may include statistical parameters such as, but not limited to, initial population, mean, standard deviation, and average distance between potential solutions in a population. The term ‘population,’ as used herein, refers to a set of potential solutions to an optimization problem. Similarly, if the optimizer is the neural network algorithm, the model parameters may include tuning parameters, initial population, and weights of neurons associated with the neural network algorithm.

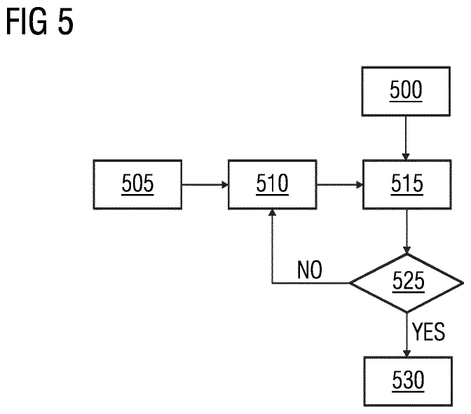

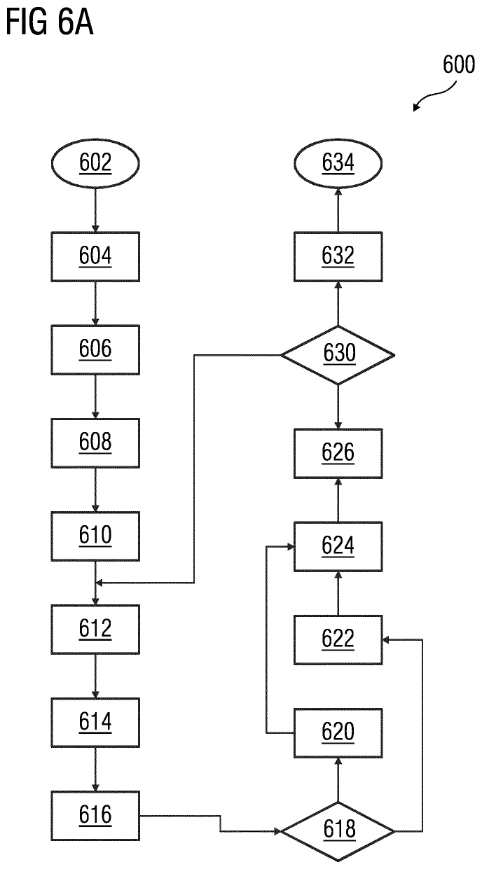

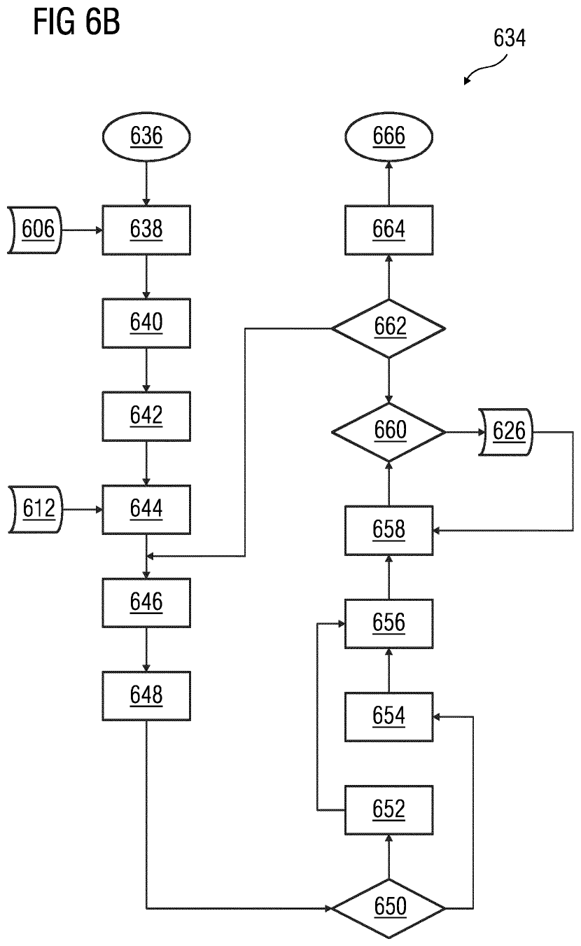

The process of transferring learnings from the source optimization task to the target optimization task using each of genetic algorithm and neural network algorithm is explained in detail with reference to FIG. 5 and FIGS. 6A-B, respectively.

FIG. 5 shows an example workflow 500 for transfer learning-based optimization using genetic algorithm, in accordance with an example embodiment.

At act 505, an initial population for the target optimization task is set to the initial population of the source optimization task.

At act 510, a minimum fitness value associated with the initial population is computed. To compute the minimum fitness value, fitness of each of the potential solutions in the initial population is evaluated using a fitness function. Further, the minimum fitness value is identified based on values of fitness corresponding to each of the potential solutions. Further, a mean of the population is set to the identified minimum fitness value.

At act 515, a new population of potential samples is generated based on the minimum fitness value of the initial population and model parameters 520 associated with the source optimizer. Herein, the model parameters 520 include a standard deviation and an average distance between potential samples, as determined from the source optimization task. For example, the model parameters 520 are used to initialize the target optimizer (e.g., the genetic algorithm for solving the target problem). In the present embodiment, the standard deviation corresponding to the source problem is used as the standard deviation for the population of act 505 corresponding to the target problem, and the average distance corresponding to the source problem is used as range of the population.

At act 520, it is determined whether a predefined condition is satisfied. In the present embodiment, the predefined condition includes a maximum number of iterations of acts 510 and 515 or the minimum fitness value is lesser than 10⁻⁶, whichever is earlier. If the predefined condition is met, act 525 is performed. Otherwise, acts 510 and 515 are iterated for the new population by replacing the initial population with the new population.

At act 525, an optima for the target problem is identified from the new population. Herein, the optima is the potential solution that provides the minimum fitness value.

FIG. 6A shows an example workflow 600 for optimization using neural network algorithm (e.g., source optimizer) in accordance with an embodiment.

The neural network algorithm is a metaheuristic optimization algorithm known in the art (Sadollah et al.) for solving optimization problems.

The neural network algorithm operates on a population of predicted solutions referred to as pattern solutions. The best pattern solution for the given target problem is identified as the target solution (e.g., best solution). The neural network algorithm aims to reduce the error between the target solution and the other predicted solutions by adjusting the values of weights and pattern solutions. The neural network algorithm is similar to Artificial Neural Networks (ANNs), as the neural network uses N input data with D dimensions and one target data (e.g., response). The target data includes the target solution X_{Goal} and the corresponding target weight W_{Goal}. The target weight W_{Goal} corresponding to the target solution X_{Goal} is selected from the population of weights in a weight matrix W. The weight matrix W is a square matrix (N×N) that includes random numbers uniformly between zero to one.

The method 600 begins at act 602.

At act 604, a user selects a population size and a number of fitness evaluations (NFE) to generate the initial population.

At act 606, a population of random pattern solutions is generated and stored in a solution matrix X₁. The population may be represented as [X11, X12 . . . . X1N], where each of X11, X12 . . . . X1N is a pattern solution.

At act 608, cost of each of the pattern solutions in the solution matrix X₁ is computed.

At act 610, a target solution X_{Goal1} and a target weight W_{Goal1} are determined based on the costs computed. For example, the target solution X_{Goal1} and the target weight W_{Goal1} correspond to the least value of cost.

At act 612, weights in the weight matrix W₁ are randomly updated based on the constraint that the summation of weights for a pattern solution does not exceed one.

At act 614, new pattern solutions X_{New1} are calculated using an equation inspired by the weight summation technique used in ANNs. Further, the population X₁ is updated with the new pattern solutions X_{New1}.

At act 616, the weight matrix W₁ is updated based on the value of the target weight W_{Goal1} using a predefined logic.

At act 618, a modification factor β is used to determine percentage of the pattern solutions to be altered using a bias operator or a transfer function operator. Here, a value of the modification factor is initialized to 1 in the first iteration. The modification factor of 1 indicates a 100% chance to modify every pattern solution in the population. Further, with each iteration, the modification factor is adaptively reduced at each iteration using a predefined reduction formulation. If a random variable is less than the value of the modification factor in an iteration, then a bias operator is applied to the population as indicated by act 620. Otherwise, a transfer function operator is applied to the population as indicated by act 622. The combination of bias operator and the transfer function operators in the neural network algorithm plays a crucial role in generating solutions to the target problem. For example, the bias operator is responsible for generating new pattern solutions during early iterations (rand <=β), while the transfer function operator plays a more significant role in final iterations (rand>β).

At act 620, the bias operator modifies a certain percentage of the pattern solutions in the new population of pattern solutions, generated at act 614, and the updated weight matrix W₁ generated at act 616. The bias operator acts as a noise to explore the population and generate pattern solutions closer to the target solution X_{Goal1}. Further, act 624 is performed on the updated population.

At act 622, the transfer function operator transfers each of the new pattern solutions from a current position to a new position in the population, to move the new pattern solutions closer to the target solution X_{Goal1}. Further, act 624 is performed on the updated population.

At act 624, a cost associated with each of the new pattern solutions is computed. If the cost is lesser than a target cost, act 626 is performed.

At act 626, the target solution X_{Goal} is updated with the pattern solution corresponding to the lowest value of cost obtained at act 624, among the set of pattern solutions. Further, the target weight W_{Goal1} is updated with the weight corresponding to the target solution X_{Goal1}.

At act 628, it is determined whether at least a predetermined stopping criterion is satisfied. If yes, act 630 is performed. Otherwise, acts 614 to 628 are repeated until the stopping criteria is met. Each such repetition is an iteration of the optimization run.

At act 630, an output indicative of the target solution X_{Goal1} and the target weight W_{Goal1} is generated.

The method ends at act 632.

FIG. 6B shows an example workflow 634 of performing transfer learning-based optimization using neural network algorithm (e.g., target optimizer) in accordance with an embodiment.

The method begins at act 636.

At act 638, a population of pattern solutions is generated by seeding the initial population of the source optimizer, obtained at act 606 of method 600. Further, the generated pattern solutions are stored in a solution matrix X₂. The population may be represented as [X21, X22 . . . . X2N], where each of X21, X22 . . . . X2N is a pattern solution.

At act 640, cost of each of the pattern solutions in the solution matrix X₂ is computed.

At act 642, a target solution X_{Goal2} and a target weight W_{Goal2} are determined based on the costs computed. For example, the target solution X_{Goal2} and the target weight W_{Goal1} correspond to the least value of cost.

At act 644, weights in a weight matrix W₂ are set to the target weight W_{Goal1} obtained at act 612 in the final iteration of method 600. This acts as a first level of transfer learning from the source optimizer.

At act 646, new pattern solutions X_{New2} are calculated using an equation inspired by the weight summation technique used in ANNs. Further, the population of pattern solutions is updated with the new pattern solutions X_{New2}.

At act 648, the weight matrix W₂ is updated based on the value of the target weight W_{Goal2} using a predefined logic.

At act 650, a modification factor β is used to determine percentage of the pattern solutions to be altered using a bias operator or a transfer function operator, similar to act 618 of method 600. If a random variable is less than the value of the modification factor in an iteration, then a bias operator is applied to the population as indicated by act 652. Otherwise, a transfer function operator is applied to the population as indicated by act 654. For example, the bias operator generates new pattern solutions during early iterations (rand <=β), while the transfer function operator plays a more significant role in final iterations (rand>β).

At act 652, the bias operator modifies a certain percentage of the pattern solutions in the new population of pattern solutions, generated at act 646, and the updated weight matrix W₂ generated at act 648. The bias operator acts as a noise to explore the population and generate pattern solutions closer to the target solution X_{Goal2}. Further, act 656 is performed on the updated population.

At act 654, the transfer function operator transfers each of the new pattern solutions from a current position to a new position in the population, to move the new pattern solutions closer to the target solution X_{Goal2}. Further, act 656 is performed on the updated population.

At act 656, a cost associated with each of the new pattern solutions is computed. If the cost is lesser than a target cost, act 658 is performed.

At act 658, the target solution X_{Goal2} is updated with the pattern solution corresponding to the lowest value of cost obtained at act 656, among the set of pattern solutions. Further, the target weight W_{Goal2} is updated with the weight corresponding to the target solution X_{Goal2}. The target solution X_{Goal2} and the target weight W_{Goal2} is further stored in a new memory location within the memory 120.

At act 660, it is determined whether the target solution X_{Goal2} and the target weight W_{Goal2} have remained same for three consecutive iterations based on values stored in the memory location. If yes, the target solution X_{Goal2} and the target weight W_{Goal2} are updated, respectively, to the target solution X_{Goal1} and the target weight W_{Goal1}, obtained at act 626 in the final iteration of method 600. This acts as the second level of transfer learning from the source optimizer.

In one embodiment, transfer at two stages (act 638 and act 644) helps the target optimizer to trace back a desired path in the population to converge to a global optima faster, even in case of a divergence during later iterations. Further, the second level of transfer learning is triggered when the target weight and target solution remain stagnant, rather than triggering at only one critical iteration.

At act 662, it is determined whether at least a predetermined stopping criterion is satisfied. If yes, act 664 is performed. Otherwise, acts 646 to 664 are repeated until the at least one stopping criterion is met. Each such repetition is an iteration of the optimization run.

At act 664, an output indicative of the target solution X_{Goal2} and the target weight W_{Goal2} is generated.

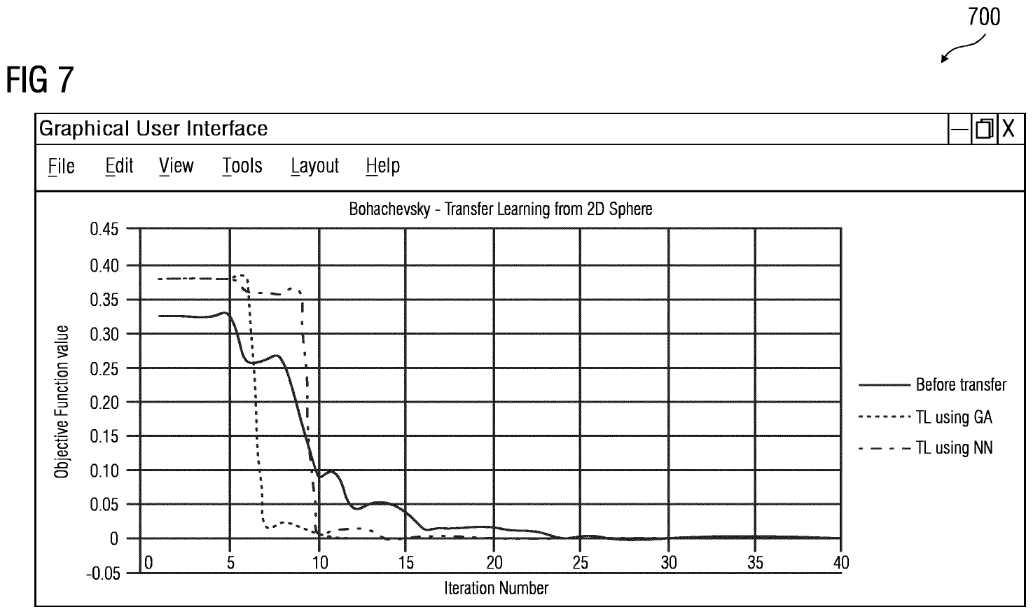

FIG. 7 shows a plot indicative of convergence of optimization for two similar functions, a 2D sphere function (e.g., source problem) and a 2D Bohachevsky function (e.g., target problem), using transfer learning based on neural network algorithm and genetic algorithm, and without using transfer learning.

Table 3 shows a comparison of convergence of optimization using a neural network algorithm with and without transfer learning from the 2D sphere function to the 2D Bohachevsky function:

TABLE 3
Convergence of optimization using a neural network algorithm.

| | |
|---|---|
| True Value (TV): | x* = (0, 0) |
| | f(x*) = 0 |

| Before Transfer (BT) | After Transfer (AT) |
|---|---|
| x* = (−0.0199, 0.0171) | x* = (0.0053, −0.0035) |
| f(x*) = 0.0011 | f(x*) = 6.06e−05 |
| Iterations = 81 | Iterations = 32 |

The notation x* denotes a target solution, while f (x*) denotes a cost function associated with the neural network algorithm. The true value indicates an actual solution to the optimization problem.

Referring to FIG. 7 and Table 3, it may be seen that without transfer learning from a source optimizer, the neural network algorithm-based target optimizer takes 81 iterations to converge and reach the near optima of the 2D Bohachevsky function. However, after transfer learning-based optimization using the neural network algorithm, the target optimizer reached the optima within 32 iterations. This example illustrates a positive transfer of learnings from the source optimization task to the target optimization task, as the transfer has resulted in faster convergence to the global optima.

Table 4 shows a comparison of convergence of optimization using genetic algorithm, with and without transfer learning from the 2D sphere function to the 2D Bohachevsky function:

TABLE 4
Convergence of optimization using genetic algorithm.

| | |
|---|---|
| True Value (TV): | x* = (0, 0) |
| | f(x*) = 0 |

| Before Transfer (BT) | After Transfer (AT) |
|---|---|
| x* = (0.3393, 0.2262) | x* = (0.0154, −0.0113) |
| f(x*) = 0.2263 | f(x*) = 0.00049 |
| Iterations = 72 | Iterations = 25 |

In the example of Table 4, the genetic algorithm-based target optimizer takes 72 iterations to converge and reach the optima of the 2D Bohachevsky function before transfer learning, and 25 iterations after transfer learning. Therefore, the genetic algorithm-based optimization also results in positive transfer of learnings from the source optimization task to the target optimization task.

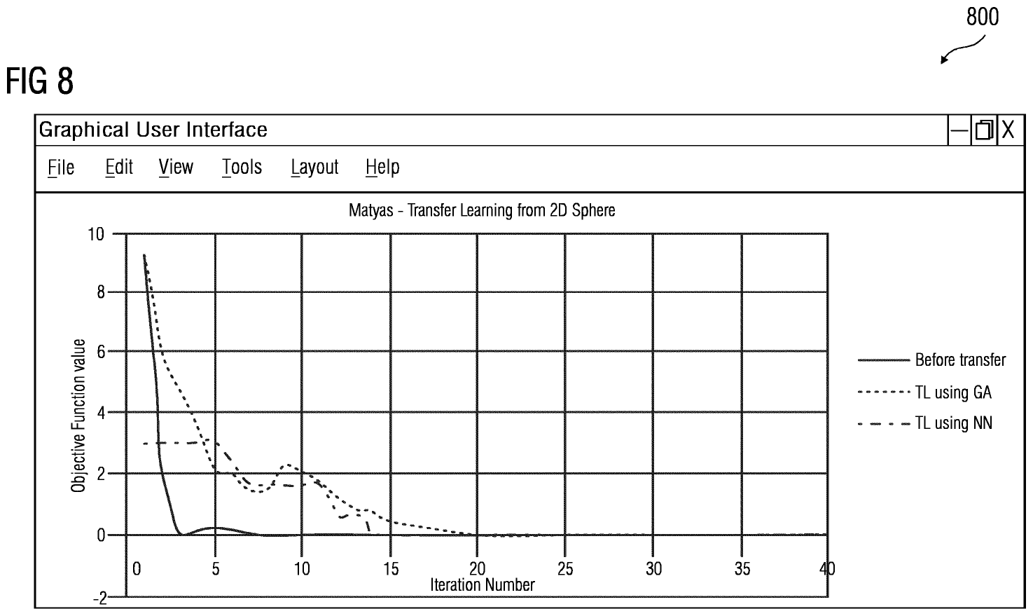

FIG. 8 shows a plot indicative of convergence of optimization for two dissimilar functions, a 2D sphere function and a 2D Matyas function, using transfer learning based on neural network algorithm and genetic algorithm, and without using transfer learning.

Table 5 shows convergence of optimization using neural network algorithm with and without transfer of learnings from the 2D sphere function to the 2D Matyas function:

TABLE 5
Convergence of optimization using neural network algorithm.

| | |
|---|---|
| True Value (TV): | x* = (1, 3) |
| | f(x*) = 0 |

| Before Transfer (BT) | After Transfer (AT) |
|---|---|
| x* = (1.0243, 2.9853) | x* = (0.9718, 3.0315) |
| f(x*) = 0.0011 | f(x*) = 0.0018 |
| Iterations = 63 | Iterations = 100 |

Referring to FIG. 8 and Table 5, it may be seen that without transfer learning from a source optimizer, the neural network algorithm-based target optimizer takes 63 iterations to converge and reach the near optima of the 2D Matyas function. However, after transfer learning-based optimization using a neural network algorithm, the target optimizer reached the optima at 100 iterations, indicating that the convergence is slower after transfer learning.

Table 6 shows convergence of optimization using a genetic algorithm with and without transfer of learnings from the 2D sphere function to the 2D Matyas function:

TABLE 6
Convergence of optimization using genetic algorithm.

| | |
|---|---|
| True Value (TV): | x* = (1, 3) |
| | f(x*) = 0 |

| Before Transfer (BT) | After Transfer (AT) |
|---|---|
| x* = (1.0003, 2.9996) | x* = (1.0293, 2.9826) |
| f(x*) = 2.8306e−7 | f(x*) = 0.0017 |
| Iterations = 23 | Iterations = 33 |

In the example of Table 6, the genetic algorithm-based target optimizer takes 23 iterations to converge and reach the optima of the 2D Matyas function before transfer learning, and 33 iterations after transfer learning. As seen from FIG. 8, Table 5, and Table 6, performing transfer learning between dissimilar functions results in negative transfer of learnings irrespective of the type of optimizer.

Further to the above, the concept of transfer learning-based optimization may be demonstrated further with an optimization problem related to three different types of motors (e.g., an Interior Permanent Magnet Synchronous Machine without frame (IPMSMA), an Interior Permanent Magnet Synchronous Machine with frame (IPMSMX), and a squirrel cage induction motor (SCIM6)). Here, IPMSMA And IPMSMX belong to the same family of motors and operate based on the same principles. On the other hand, SCIM6 belongs to a different family of motors and operates based on principles different from that of IPMSMX and IPMSMA.

In the present example, stator slot opening and magnet width may be considered as design variables for each of the motors. Further, an optimization problem for minimizing a torque ripple in each of the motors may be formulated based on the corresponding design variables.

$$IPMSMX : 10.21 -- 675.9 * {X}_{1} + 1419 * {X}_{2} - 5.747 e 04 * {X}_{1}^{2} - 2.838 e 04 * {X}_{1} * {X}_{2} + 2767 * {X}_{2}^{2} = 0 \qquad ( 11 )$$

$$IPMSMA : 9.645 -- 600.7 * {X}_{1} + 1592 * {X}_{2} - 6.398 e 04 * {X}_{1}^{2} - 3.441 e 04 * {X}_{1} * {X}_{2} = 0 \qquad ( 12 )$$

As shown from the above equations, the optimization problem for IPMSMX is a ‘poly22’ function including six terms, whereas the optimization task for IPMSMA is a ‘poly21’ function including five terms. Therefore, the complexity score corresponding to the optimization problem related to IPMSMX is higher than that of IPMSMA owing to the higher number of terms in the optimization problem.

The results of transfer learning-based optimization for different scenarios are tabulated in tables.

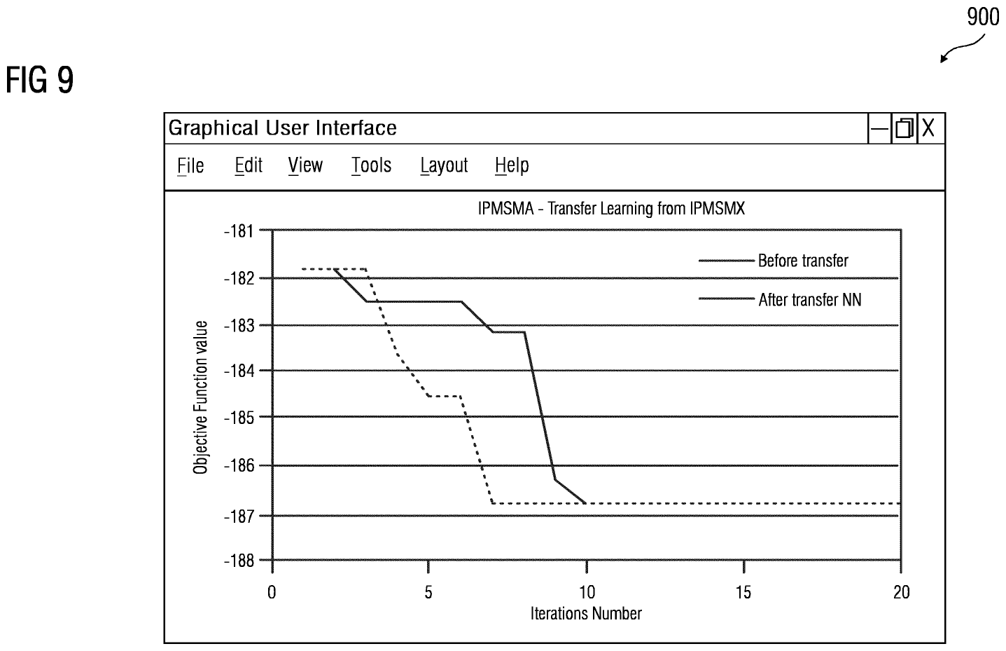

FIG. 9 is a plot showing comparison between convergence of optimization with and without transfer of learnings from the optimization problem for IPMSMX to the optimization problem for IPMSMA. Table 7 below shows similarity indices computed for the optimization tasks corresponding to IPMSMX and IPMSMA.

TABLE 7
Experimental results for similarity indices computed for
optimization tasks corresponding to IPMSMX and IPMSMA
Similarity Analysis

| | |
|---|---|
| Cosine Similarity | 0.9985 |
| Pearson Similarity | 0.9558 |
| SSIM | 0.9057 |
| MSE | 0.0042 |
| 1-- Norm MSE | 0.9958 |
| Jaccard Similarity | 0.8680 |
| Visualization | Similar |

It may be understood that since both IPMSMX and IPMSMA belong to the same class of motors, as a result, the similarity indices are indicative of a high degree of similarity between the optimization problems.

Table 8 shows convergence of optimization using a neural network algorithm, with and without transfer of learnings from the optimization problem for IPMSMX to the optimization problem for IPMSMA.

TABLE 8
Convergence of optimization using neural network algorithm.

| | |
|---|---|
| True Value (TV): | x* = (0.05, 0.05) |
| | f(x*) = −186.765 |

| Before Transfer (BT) | After Transfer (AT) |
|---|---|
| x* = (0.05, 0.05) | x* = (0.05, 0.05) |
| f(x*) = −186.765 | f(x*) = −186.765 |
| Iterations = 10 | Iterations = 7 |

As may be understood from the number of iterations shown in Table 8, the transfer of learnings from the optimization problem for IPMSMX to the optimization problem for IPMSMA leads to a faster convergence rate.

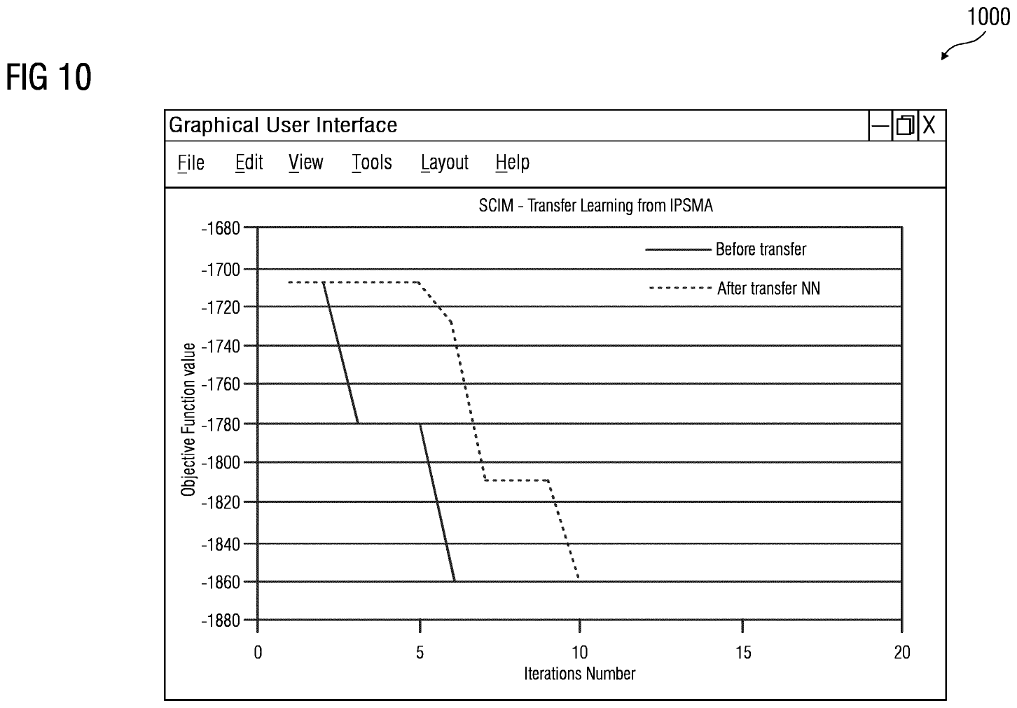

FIG. 10 shows a plot showing comparison between convergence of optimization with and without transfer of learnings from the optimization problem for IPMSMX to the optimization problem for SCIM6.

Table 9 below shows similarity indices computed for optimization problems corresponding to IPMSMX and SCIM6.

TABLE 9
Similarity indices for optimization problems
corresponding to IPMSMX and SCIM6
Similarity Analysis

| | |
|---|---|
| Cosine Similarity | 0.9718 |
| Pearson Similarity | 0.8397 |
| SSIM | 0.653 |
| MSE | 0.074 |
| 1-- Norm MSE | 0.9260 |
| Jaccard Similarity | 0.3639 |
| Visualization | Dissimilar |

As may be seen from Table 9, the similarity indices indicate that the optimization tasks are dissimilar. Consequently, transfer of learnings from the optimization task of IPMSMA to the optimization task for SCIM6 leads to negative transfer learning as shown in Table 10.

Table 10 shows convergence of optimization using neural network algorithm, with and without transfer of learnings from the optimization problem for SCIM6 to the optimization problem for IPMSMX.

TABLE 10
Convergence of optimization using neural network algorithm.

| | |
|---|---|
| True Value (TV): | x* = (0.05, 1e−8) |
| | f(x*) = −1860.15 |

| Before Transfer (BT) | After Transfer (AT) |
|---|---|
| x* = (0.05, 1e−8) | x* = (0.05, 0.05) |
| f(x*) = −1860.15 | f(x*) = −1860.15 |
| Iterations = 6 | Iterations = 10 |

Therefore, it may be appreciated that determining similarity between two optimization problems prior to initiating transfer learning helps avoid negative transfer learning.

In addition to the above, transfer of learnings from an optimization problem of low complexity (e.g., knowledge-deficit source problem) to an optimization task of high complexity (e.g., knowledge-rich target problem) also leads to negative transfer, as indicated by the test results of Table 11.

Table 11 shows results of transfer of learnings from the optimization problem of IPMSMA (e.g., knowledge-deficit source problem) to the optimization problem of IPMSMX (e.g., knowledge-rich target problem):

TABLE 11
Convergence of optimization using neural network algorithm.

| | |
|---|---|
| True Value (TV): | x* = (0.05, 1e−8) |
| | f(x*) = −167.26 |

| Before Transfer (BT) | After Transfer (AT) |
|---|---|
| x* = (0.05, 1e−8) | x* = (0.05, 0.05) |
| f(x*) = −167.26 | f(x*) = −1860.15 |
| Iterations = 8 | Iterations = 10 |

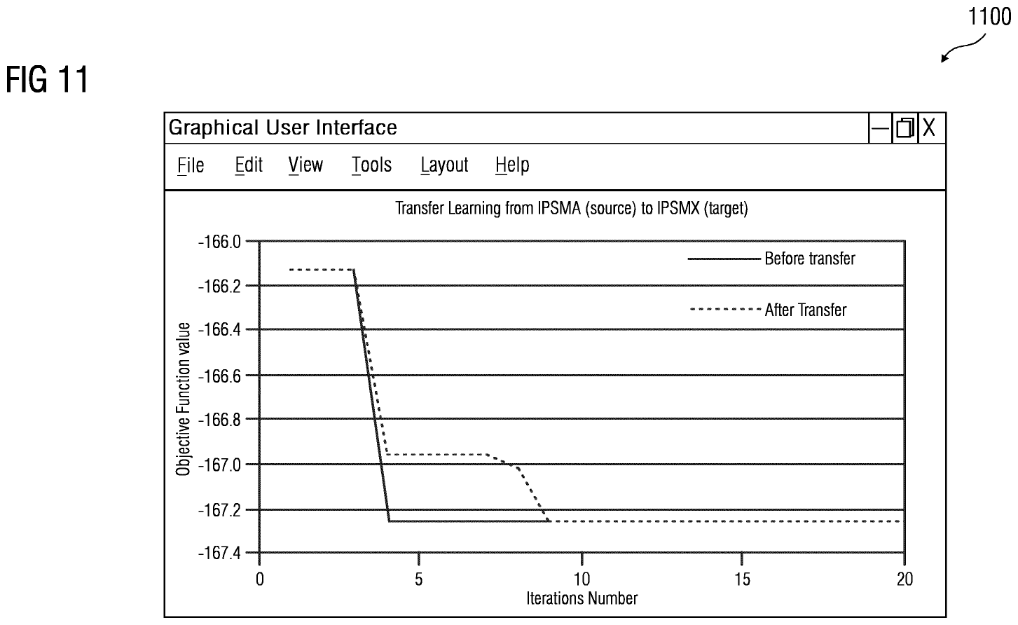

FIG. 11 shows a plowing comparison between convergence of optimization with and without transfer learnings from a knowledge-deficit source problem to a knowledge-rich target problem. As seen from Table 11 and FIG. 11, the convergence rate reduces after transfer learning, leading to negative transfer, when the source problem is less complex compared to the target problem.

Therefore, for similar optimization problems, it is also necessary to provide that transfer of learnings is performed from an optimization task of higher complexity to an optimization problem of lower complexity to avoid negative transfer.

The present embodiments enable determination of whether positive transfer learning is possible between two optimization problems, at two stages. The first stage is associated with determining similarity between the optimization tasks, while the second stage is associated with comparing complexity levels of the optimization problems. This helps a researcher to make cautious decisions on transfer learning to avoid negative transfer learning, thereby reducing computational complexity and unwanted costs.

While the invention has been illustrated and described in detail with the help of example embodiments, the invention is not limited to the disclosed examples. Other variations may be deducted by those skilled in the art without leaving the scope of protection of the claimed invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method comprising:
receiving, from a client device, by a processing unit, an input indicative of a target optimization task, wherein the target optimization task is associated with an unsolved optimization problem;
determining similarity between the target optimization task and at least one source optimization task, the determining of the similarity comprising applying a predefined similarity checking logic, wherein the at least one source optimization task is associated with a solved optimization problem and a complete optimization history of the solved optimization problem; and
generating an output indicative of an outcome of the applying of the predefined similarity checking logic on a user interface of the client device.

2. The method of claim 1, wherein determining similarity between the target optimization task and the at least one source optimization task further comprises:
performing a low-level check to determine similarities based on metadata, features, or metadata and features present in the at least one source optimization task and the target optimization task;
when the low-level check is indicative of a similarity between the at least one source optimization task and the target optimization task, performing a high-level check to compute a plurality of similarity indices; and
determining the outcome based on values of the plurality of similarity indices,
wherein the outcome is indicative of similarity or dissimilarity between the at least one source optimization task and the target optimization task.

3. The method of claim 2, wherein the high-level check is based on interpretable self-organizing maps, image comparison, Pearson coefficient, cosine similarity, Jaccard similarity, mean square error, structural similarity index, visualization, or any combination thereof.

4. The method of claim 1, further comprising:
computing complexity scores associated with each of the at least one source optimization task and the target optimization task using a predefined logic, subject to the outcome of the applying of the predefined similarity checking logic; and
determining whether a complexity of the at least one source optimization task is greater than a complexity of the target optimization task, the determining of whether the complexity of the at least one source optimization task is greater than the complexity of the target optimization task comprising comparing the estimated complexity scores associated with each of the at least one source optimization task and the target optimization task.

5. The method of claim 1, further comprising:
when complexity of the at least one source optimization task is greater than complexity of the target optimization task:
initiating transfer learning from the at least one source optimization task to the target optimization task.

6. The method of claim 2, wherein initiating transfer learning from the at least one source optimization task to the target optimization task comprises:
selecting a target optimizer from a plurality of optimizers based on the complete optimization history of the solved optimization problem.

7. The method of claim 6, wherein initiating transfer learning from the source optimization task to the target optimization task further comprises:
identifying, from the source optimization task, an initial population and one or more model parameters associated with a source optimizer employed in the source optimization task, wherein the one or more model parameters are associated with least model error in the source optimizer;
adapting the target optimizer based on the identified initial population and the one or more model parameters; and
using the adapted target optimizer for generating a solution to the unsolved optimization problem.

8. The method of claim 7, wherein each of the source optimizer and the target optimizer is a metaheuristic optimization algorithm.

9. The method of claim 8, wherein the metaheuristic optimization algorithm is one of a genetic algorithm or neural network algorithm.

10. The method of claim 7, further comprising:
generating a notification indicative of at least the solution to the unsolved optimization problem, on the user interface of the client device.

11. An apparatus comprising:
one or more processing units; and
a memory unit communicatively coupled to the one or more processing units, wherein the memory unit comprises a comparison module stored in the form of machine-readable instructions executable by the one or more processing units, wherein the comparison module is configured to:
receive, from a client device, an input indicative of a target optimization task, wherein the target optimization task is associated with an unsolved optimization problem;
determine similarity between the target optimization task and at least one source optimization task, the determination of the similarity comprising application of a predefined similarity checking logic, wherein the at least one source optimization task is associated with a solved optimization problem and a complete optimization history of the solved optimization problem; and
generate an output indicative of an outcome of the application of the predefined similarity checking logic on a user interface of the client device.

12. A system comprising:
one or more client devices; and
an apparatus communicatively coupled to the one or more client devices, wherein the apparatus is configured for enabling transfer learning-based optimization based on inputs received from the one or more client devices, the apparatus comprising:
one or more processing units; and
a memory unit communicatively coupled to the one or more processing units, wherein the memory unit comprises a comparison module stored in the form of machine-readable instructions executable by the one or more processing units, wherein the comparison module is configured to:
receive, from a client device of the one or more client devices, an input indicative of a target optimization task, wherein the target optimization task is associated with an unsolved optimization problem;
determine similarity between the target optimization task and at least one source optimization task, the determination of the similarity comprising application of a predefined similarity checking logic, wherein the at least one source optimization task is associated with a solved optimization problem and a complete optimization history of the solved optimization problem; and
generate an output indicative of an outcome of the application of the predefined similarity checking logic on a user interface of the client device.

13. A computer-program product having machine-readable instructions stored therein that, when executed by one or more processing units, cause the one or more processing units to:
receive, from a client device, an input indicative of a target optimization task, wherein the target optimization task is associated with an unsolved optimization problem;
determine similarity between the target optimization task and at least one source optimization task, the determination of the similarity comprising application of a predefined similarity checking logic, wherein the at least one source optimization task is associated with a solved optimization problem and a complete optimization history of the solved optimization problem; and
generate an output indicative of an outcome of the application of the predefined similarity checking logic on a user interface of the client device.
